(19) United States
(12) Patent Application Publication
(10) Pub. No.: US 2012/0091817 A1
(43) Pub. Date: Apr. 19, 2012

(54) SYSTEM, METHOD, AND APPARATUS FOR AC GRID CONNECTION OF SERIES-CONNECTED INVERTERS

(75) Inventors: Eric Seymour, Fort Collins, CO (US); Mike Armstrong, Fort Collins, CO (US); Jack Arthur Gilmore, Fort Collins, CO (US)

(73) Assignee: ADVANCED ENERGY INDUSTRIES, INC., Ft. Collins, CO (US)

(21) Appl. No.: 13/275,259

(22) Filed: Oct. 17, 2011

Related U.S. Application Data
(60) Provisional application No. 61/393,987, filed on Oct. 18, 2010.

(51) Int. Cl. H02M 7/5387

(52) U.S. Cl. 307/82; 363/132; 363/71

(57) ABSTRACT

A system, method and apparatus are disclosed for converting DC power to AC power. The system includes a master controller that couples to a phase of a power distribution system and provides a synchronization signal, the phase of the power distribution system having a phase voltage. The system also includes a plurality of DC-to-AC series-connectable power converters, that receive and use the synchronization signal to convert a variable DC voltage from a corresponding one a plurality of photovoltaic panels to a variable AC voltage so that a plurality of corresponding variable AC voltages are generated by the plurality series-connectable power converters, and collectively the plurality of corresponding variable AC voltages add up the phase voltage, and each of the series-connectable power converters controls, responsive to the synchronization signal, the variable AC voltage so that the plurality of corresponding variable AC voltages are in phase.

### PRIORITY

This application claims priority to U.S. provisional application No. 61/393,987 filed Oct. 18, 2010 entitled SYSTEM, METHOD AND APPARATUS FOR AC GRID CONNECTION OF SERIES-CONNECTED PHOTOVOLTAIC INVERTERS.

### FIELD OF THE INVENTION

This invention relates generally to apparatus and methods for converting solar energy to electrical energy, and more specifically to apparatus and methods for more efficient and/or effective conversion of solar energy to electrical energy.

### BACKGROUND OF THE INVENTION

The transformation of light energy into electrical energy using photovoltaic (PV) systems has been known for a long time and these photovoltaic systems are increasingly being implemented in residential, commercial, and industrial applications. Although developments and improvements have been made to these photovoltaic systems over the last few years to improve their effectiveness and efficiency, continued improvement in effectiveness and efficiency of photovoltaic systems is being sought in order to make photovoltaic systems more economically viable.

Photovoltaic systems typically include, among other components, photovoltaic modules and a power converter(s). In the case where the photovoltaic system is connected to an AC electrical grid, the power converter(s) invert the electrical power from DC to AC. These devices, or inverters, are available in a broad range of sizes ranging from those small enough to connect to a single photovoltaic module to those capable of processing the power from thousands of modules. The size of an inverter may be chosen that best suits the specific characteristics of the photovoltaic system.

Existing photovoltaic inverters, regardless of size, connect to the AC grid with a parallel, or shunt, connection as is done with other grid-connected devices. Parallel grid connections provide constant voltage to the connected device and offer nearly complete independence between connected devices.

Photovoltaic system design is continuously evolving in an effort to reduce system cost. It is for this reason that alternatives to present designs and methods of operation of photovoltaic power transfer and conversion are sought.

### SUMMARY OF THE INVENTION

Some aspects of the present invention may be characterized as a system for converting DC power to AC power. The system may include a master controller that couples to a phase leg of a power distribution system and provides a synchronization signal and a power control signal, the phase leg of the power distribution system having a phase voltage. In addition the system includes a plurality of DC-to-AC series-connectable power converters arranged in series in a string, each of the DC-to-AC series-connectable power converters receives and uses the synchronization signal and the power signal to convert a variable DC voltage from a corresponding one of a plurality of photovoltaic modules to an AC voltage so that a plurality of corresponding AC voltages are generated by the plurality of series-connectable power converters, and collectively the plurality of corresponding AC voltages add up the phase voltage, and each of the series-connectable power converters controls, responsive to the synchronization signal, the AC voltage so that the plurality of corresponding variable AC voltages are all in phase.

In other embodiments, the invention may be characterized as a DC-to-AC series-connectable power converter that includes a DC-input side including terminals to couple to a DC potential applied by a corresponding one of a plurality of photovoltaic modules; an AC-output side including terminals to apply an AC voltage; and a receiver to receive a synchronization signal and a power signal. The DC-to-AC series-connectable power converter also includes a power conversion component to convert the DC potential applied by the corresponding one of a plurality of photovoltaic modules to the AC voltage and a controller that controls the power conversion component, responsive to the received synchronization signal and the power signal, so that a phase of the AC voltage is synchronized with the synchronization signal and a power level output from the DC-to-AC series-connectable power converter is consistent with the power signal.

Consistent with several embodiments, the invention may be characterized as a method for converting DC power to AC power. The method includes arranging AC outputs of each of a plurality of DC-to-AC power converters in series with others of the DC-to-AC power converters; receiving, at each of the DC-to-AC power converters, a synchronization signal; converting, with each of the DC-to-AC power converters, DC power to AC power using the synchronization signal so that AC voltages output by the DC-to-AC power converters are in phase; and applying the AC power to a phase leg of a power distribution system, a total voltage applied to the phase leg of the distribution system equals a sum of the AC voltages output by the DC-to-AC power converters.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a diagram depicting series connected photovoltaic modules connected at their respective DC outputs as is known in the prior art;

FIG. 2 is a diagram depicting photovoltaic modules arranged in parallel as is known in the prior art;

FIG. 3A is a diagram depicting an exemplary system including series-connectable DC-to-AC converters that operates according to several embodiment of the present invention;

FIG. 3B is a block diagram depicting an exemplary embodiment of a series-connectable DC-to-AC converter;

FIG. 4 is a schematic depiction of an exemplary embodiment of a series-connectable DC-to-AC converter, which may be utilized to implement the DC-to-AC converters described with reference to FIGS. 3A and 3B;

FIG. 5 is a schematic depiction of another exemplary embodiment of a series-connectable DC-to-AC converter, which may be utilized to implement the DC-to-AC converters described with reference to FIGS. 3A and 3B;

FIG. 6, it is a block diagram depicting an exemplary control component that may be utilized to realize the control components described with reference to FIGS. 3, 4 and 5;

FIG. 7 is a schematic representation of yet another embodiment of a series-connectable DC-to-AC converter, which may be utilized to implement the DC-to-AC converters described with reference to FIGS. 3A and 3B;

FIG. 8 is a block diagram depicting an exemplary embodiment of the control portion depicted in FIG. 7;

FIG. 9 is a block diagram depicting yet another exemplary embodiment of the control portion depicted in FIG. 7;

FIG. 10 is a block diagram depicting yet another exemplary embodiment of the control portion depicted in FIG. 7;

FIGS. 11A and 11B are, respectively, a block diagram depicting components of a transmitter portion, which may be implemented as part of a supervisory transmitter described with reference to FIG. 3A, and sync pulses that may be generated by the transmitter portion;

FIGS. 12A and 12B are, respectively, a block diagram depicting components of an exemplary sync receiver and sync pulses that may be received and decoded with the sync receiver;

FIG. 13 is a block diagram depicting an exemplary arrangement for coupling a supervisory transmitter to an AC distribution system;

FIGS. 14A and 14B are, respectively, a phasor diagram and exemplary configuration of a single-phase implementation;

FIGS. 15A and 15B are, respectively, a phasor diagram and exemplary configuration of a split single-phase implementation;

FIGS. 16A and 16B are, respectively, a phasor diagram and exemplary configuration of a three-phase wye implementation;

FIGS. 17A and 17B are, respectively, a phasor diagram and exemplary configuration of a three-phase delta implementation; and

FIG. 18 is a flowchart depicting an exemplary method that may be traversed in connection with the embodiments disclosed herein.

### DETAILED DESCRIPTION

The generating capacity connected to a power grid includes of variety of device types including synchronous machines, induction machines and power electronic based devices such as inverters. These respective devices types contain a wide variety of characteristics. For example, synchronous machines connected to prime movers behave very much like ideal voltage sources, while are characteristically similar to sources of current. However, in one characteristic they are identical: they are all connected in parallel to the grid.

A parallel connection provides constancy of voltage, with associated, embedded synchronization information required to operate synchronous machines or inverters. This parallel connection arrangement is used for all generation resources from steam turbines and gas turbines to wind and photovoltaic generation.

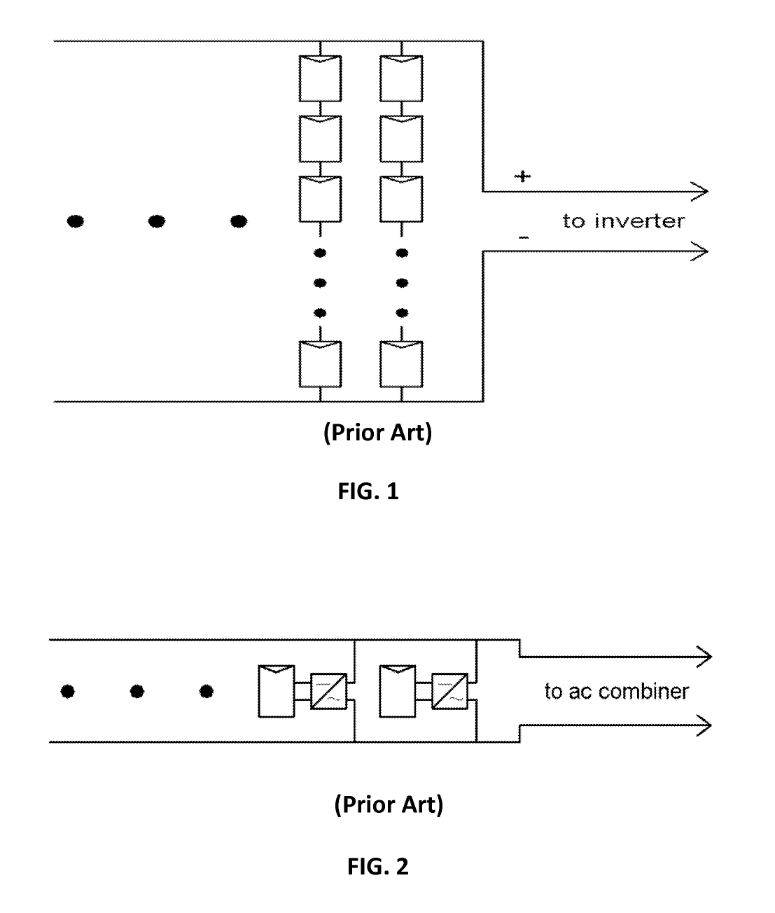

Photovoltaic systems include photovoltaic cells packaged into modules, sometimes referred to as panels, by manufacturers. The modules are then installed on site. Unlike the previously mentioned method of ac-grid generation parallel connection, it is most economical to connect the DC outputs of the photovoltaic modules in a series string as shown in FIG. 1. This series connection allows the relatively low output voltage of the module to be stacked to a more usable voltage required by the inverter. The series connection also allows for optimal use of the wire used in the string as all the wire is forced to carry the same current. It is further assumed the wire gauge is appropriately sized for this current.

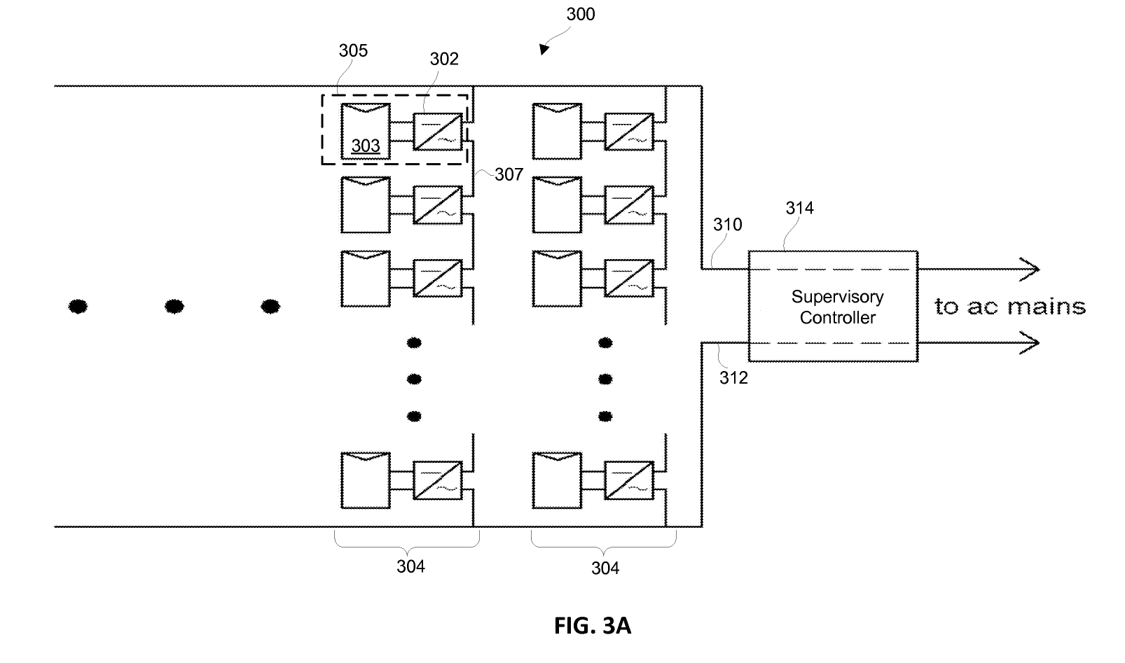

There exists a class of photovoltaic conversion equipment capable of taking one or more paralleled photovoltaic modules and inverter power to the AC grid without stacking the panels into strings or the higher dc voltages created by strings. Such devices place the AC-grid connections of the modules in parallel as shown in FIG. 2. These devices afford a variety of benefits such as highly refined data reporting down to the module level as well as individualized maximum power point tracking appropriate for highly demanding applications where shade or other sources of irradiance asymmetry are presented to the array. Drawbacks to this parallel connected arrangement include difficulty in efficiently converting a low-value dc voltage to an ac-grid voltage that is much higher. Additionally, the ac wires that are used to collect the power from the parallel string are not uniformly loaded. While it is possible to gradate the gauge of the collection wires over the length of the parallel string to allow for optimized use of conductor, this is often not practical or permitted by regulatory standard.

Applicants have therefore found it desirable to create a device capable of providing the benefits of individualized data reporting and individualized module maximum power point operation, while avoiding the drawbacks of high-voltage-ratio DC-to-AC power conversion and underused conductors.

Applicants have found that there are a variety of difficulties associated with connecting AC generating sources in series on the AC side of their outputs. First, the operation of the series-connected AC generating sources has the tendency to mask the applied grid phase voltage from the devices themselves. This is especially problematic since a requirement of any AC grid-connected generating source is the ability to create a counter-voltage identical to the applied phase voltage. Generators operating in this state do not deliver any current and by extension, real or reactive power. When a generator, whether it is a rotating machine or power electronic device such as an inverter, departs from this matched counter-voltage state, the result is current and power flow. If a generator is prevented from seeing the AC utility voltage, or at least a portion of its embedded information, then creation of the counter voltage is not possible. From this, several challenges arise: first, the dissemination of necessary grid phase voltage information to all series-connected generating sources; and second, the application of device topologies and controls appropriate for real-time creation of the necessary counter-voltage and the associated desired real and reactive power.

Parallel-connected generators, whether rotating machines or inverters, operate with a near-decoupling of phase parameters of magnitude and phase. More simply, the magnitude of the generated counter-voltage is strongly associated with delivered reactive power, while the phase of the generated counter-voltage, with respect to the applied grid voltage, is strongly associated with delivered real power.

With a string of series-connected generating devices, the collective string operates in the same manner, but the individual AC generating sources do not. Individually, each of the AC generating sources cannot solely determine the overall applied phase voltage. Although it is certainly possible that the output power of a series-connected inverter could be increased by raising the output voltage, such a course of action comes with the unintended consequence of changing the magnitude of the strings' collective counter-voltage and reactive power flow.

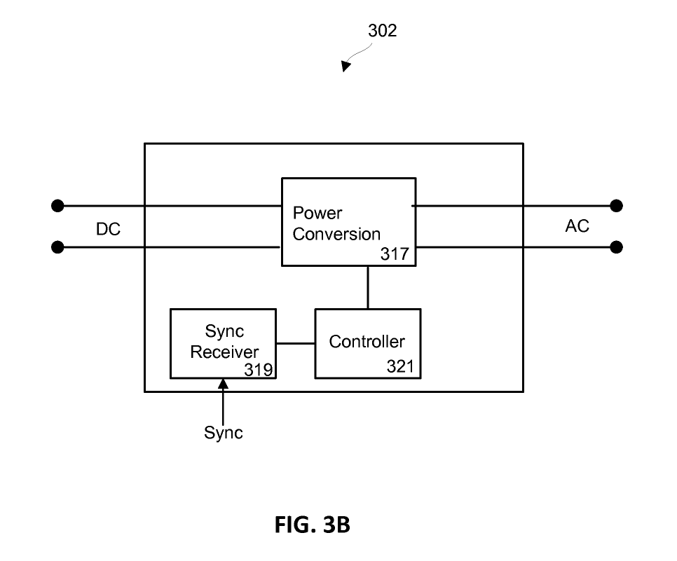

Referring next to FIG. 3A, shown is an exemplary system 300 that operates according to several embodiments of the invention. As shown, in this implementation several series connectable DC-to-AC converters 302 (also referred to herein as series-connectable inverters 302) are connected in series on the AC side of their outputs 307 and are arranged in strings 304, and each of the several strings 304 is arranged in parallel with other ones of the strings 304 to provide outputs 310, 312 that are coupled to a supervisory controller 314 and AC mains. Each of the DC-to-AC converters 302 in this embodiment is coupled to a photovoltaic module 303 (which may include one or more panels), and collectively the DC-to-AC converter 302 and corresponding photovoltaic module 303 form an AC generating source 305; thus each string 304 includes several series-connected AC generating sources 305. The photovoltaic module 303 may include, for example, a 24V panel, but other panel voltages may certainly be utilized. The sum total of the AC generating sources 305 in this embodiment is the voltage on the AC power distribution system (e.g., AC grid). And as discussed further herein, in alternative 3-phase configurations, the strings 304 may be arranged in delta and wye configurations.

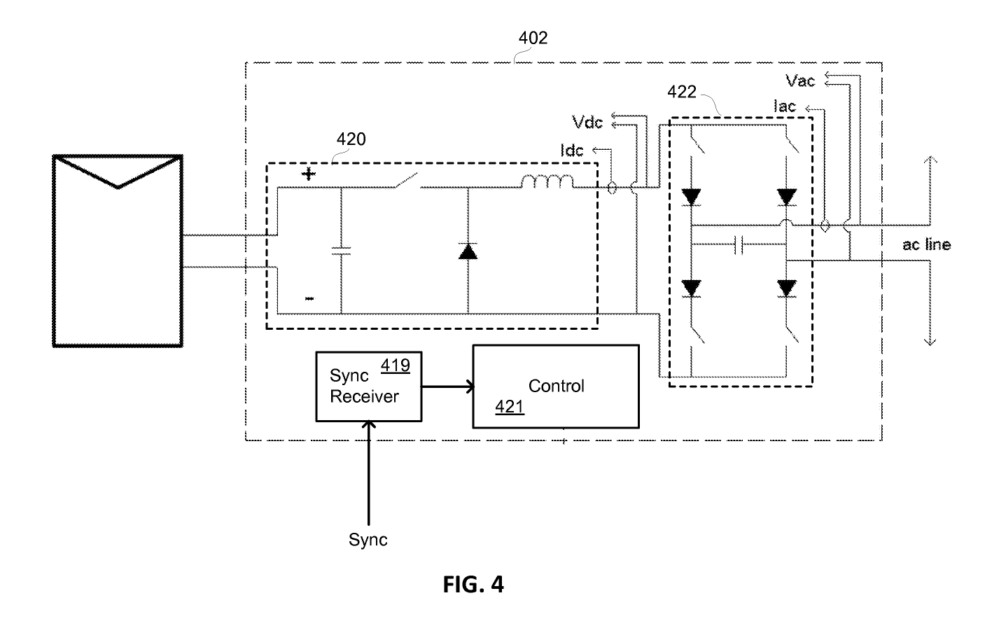

Referring next to FIG. 3B, shown is a block diagram depicting an exemplary embodiment of the series-connectable DC-to-AC converter 302 (also referred to herein as a series-connectable inverter) that may be used to realize the DC-to-AC convertors 302 depicted in FIG. 3A. As depicted, a power conversion component 317 is coupled to a controller 321, which is coupled to a sync receiver component 319. The power conversion component 317 is generally configured to convert DC power at its input to AC power at its output, and responsive to control signals from the controller 321, the power conversion component 317 is adapted to apply power at its output at an AC voltage that is in phase with the AC voltages output from other DC-to-AC converters. In addition, many embodiments of the power conversion component 317 are also configured to apply an AC voltage that may vary in magnitude, and apply power using maximum power point tracking techniques. Additional details of exemplary embodiments of the power conversion component 317 are described with reference to FIGS. 4, 5 and 7.

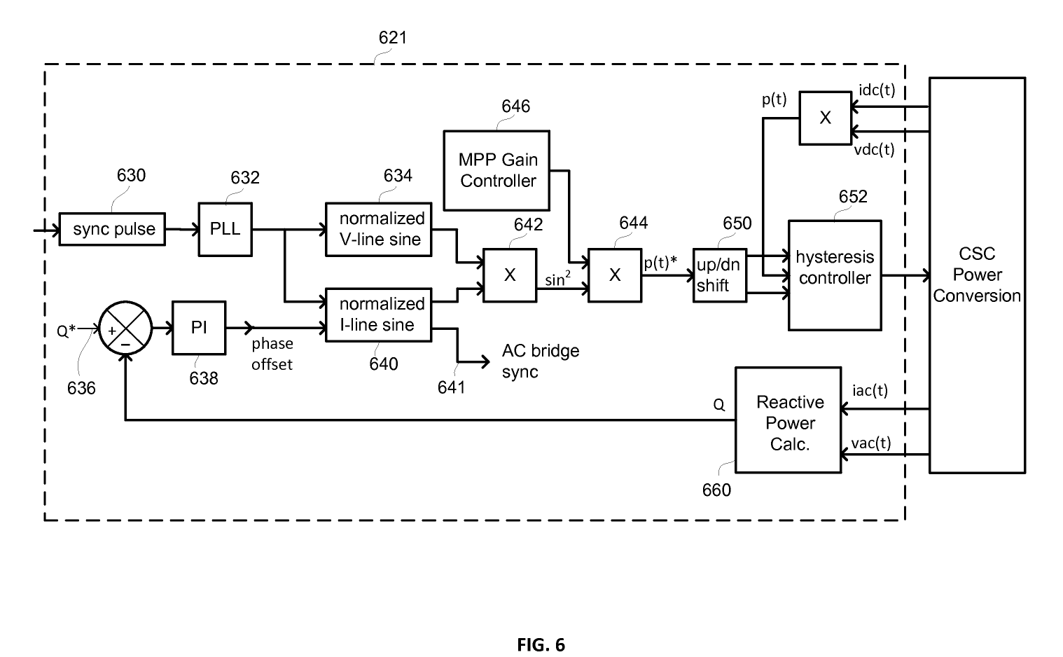

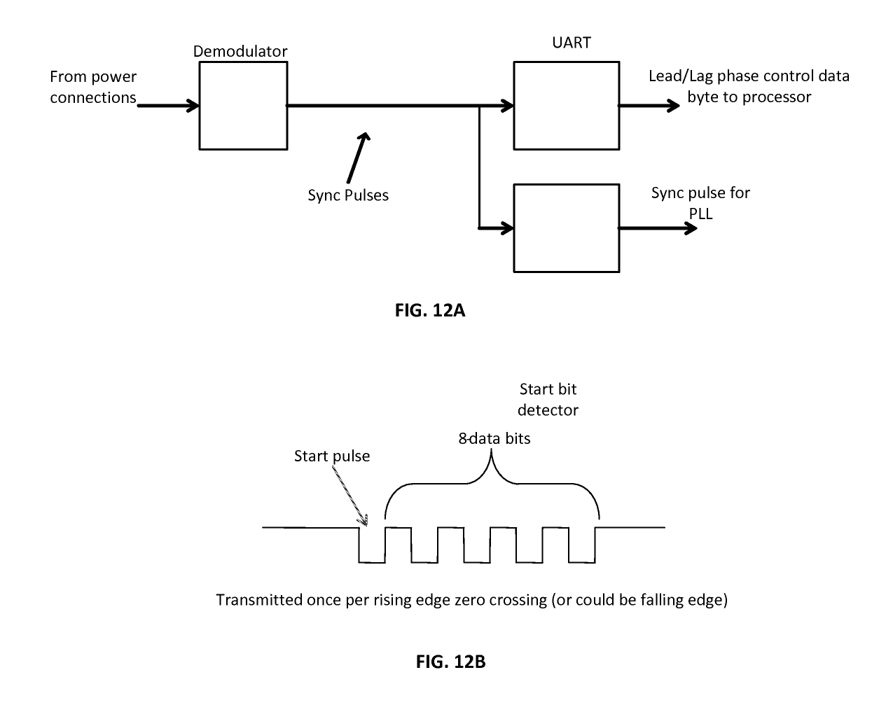

The controller 321 generally controls, responsive to synchronization information received at the sync receiver 319, operation of the power conversion component 317 so that the AC outputs of the power conversion component 317 may be coupled in series with the AC outputs of other DC-to-AC converters. Exemplary embodiments of the controller 321 are described with reference to FIGS. 6 and 8, 9, and 10 and an exemplary embodiment of the sync receiver 319 is discussed with reference to FIG. 12A.

The sync signal that is provided to the sync receiver 319 (e.g., from the supervisory controller 314) may include several pieces of decodable information. For example, shutdown information may be sent to the sync receiver 319 during an islanded event (e.g., a utility that is coupled to the series connectable DC-to-AC converters 302 experiences a failure) or when the series-connectable DC-to-AC converter 302 is simply turned off. In addition, power, timing, and phase information (e.g., to provide reactive power) may also be received with the sync signal. The power information may be a maximum power signal that may be used to reduce the power that is output from the series-connectable DC-to-AC inverter 302 (e.g., in the event of power curtailment). The timing information in many implementations is indicative of the zero crossings on the AC distribution system (on the phase connections where the supervisory controller 314 is coupled), and the phase information may include the desired phase between the current and voltage at the AC output of the series-connectable DC-to-AC inverter 302 (e.g., some embodiments of the converter 302 can control reactive power responsive to the phase information). As one of ordinary skill in the art will appreciate, the medium for the sync signal may include wireline communication, an RF link, powerline carrier technology, and optical links.

Although not depicted in FIG. 3A, the series-connectable converter 302 may also include a reporting mechanism to report the health of the corresponding panel 303 or its internal components back to the supervisory transmitter 314.

Referring next to FIG. 4, it is a schematic depiction of an exemplary embodiment of a series-connectable converter 402, which may be utilized to implement the series-connectable converters 302 described with reference to FIGS. 3A and 3B. As depicted, the series-connectable converter 402 includes a regulated buck converter 420, operated in a real-time power control mode, which feeds a line-synchronized current-source H-bridge 422. In this embodiment, the power conversion component 317 depicted in FIG. 3B is realized by the buck converter 420 in connection with the current source H-bridge 422. Also depicted are DC voltage (Vdc) and current (Idc) measurements that are taken at the output of the buck regulator 420 to enable the control component 421 to regulate the buck converter 420 on power. And AC voltage (Vac) and current (Iac) measurements (at the output of the H-bridge 422), in connection with synchronization information received at the sync receiver 419, enable the control component 421 to control the switching of the H-bridge 422 to synchronize Vac with the AC distribution system and the outputs of other series-connectable converters 402.

Applicants have found that producing real-time counter voltage is something very close in behavior to a true current source. Current sources will natively produce counter-voltages identical to that which is applied. The difficulty of this constraint is that current source devices do not “like” to be connected in series. And among other hurdles Applicants have overcome with the embodiment depicted in FIG. 4, Applicants have arrived at a current source device that can be connected in series and exhibits current source behavior operating in the collective, or string 304, arrangement.

In this embodiment, the duty cycle of the buck converter 420 is controlled (by the control portion 421) to regulate the power at its output, which is provided to the H-bridge 422. And the H-bridge 422 converts the power that is output from the buck converter 420 to AC power responsive to the control portion 421. For clarity, connections between the control component 421 and the buck converter 420; connections between the control portion 421 and the H-bridge 422; and connections between the voltage and current measurements (Vdc, Idc, Vac, Iac) and the control portion 421 are omitted.

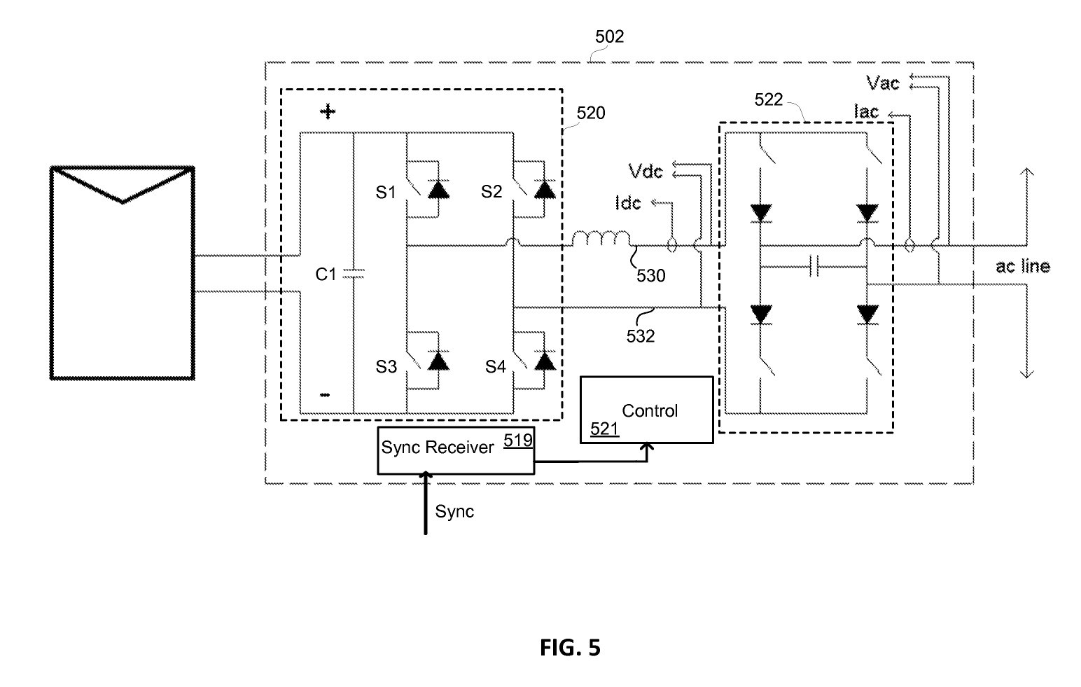

Referring next to FIG. 5, it is a schematic view of another embodiment of a series-connectable converter 502, which is capable of providing bidirectional power flow through a power regulating stage. The bidirectional aspect of the series-connectable converter 502 allows for delivery of consumptive or generative reactive power in addition to real power. This exemplary series-connectable converter 502 utilizes a periodic synchronization signal, as well as active and reactive control information (which may be encoded) that are transmitted from the supervisory controller 314 that connects across the phase connections of the AC distribution system.

As shown, a converter 520 includes four switches S1, S2, S3, and S4, which are controlled to enable the series-connectable converter 502 to provide bidirectional power. In the exemplary embodiment, when the series-connectable converter 502 is providing real power, S4 is always on and the switching of Si is modulated so that a first input 530 to the inversion bridge 522 is positive and a second input 532 to the inversion bridge 522 is negative. And in contrast, when providing reactive power, S2 is always on and the switching of S3 is modulated so that the first input 530 to the inversion bridge 522 is negative and the second input 532 to the inversion bridge 522 is positive to reverse power flow, which is stored, at least in part, by the capacitor C1.

In operation, the control portion 521 receives a signal (e.g., via the sync receiver 519) to change the direction of power flow responsive to communication (e.g., from the supervisory controller 314) that may be initiated when it is desirable to apply reactive power to (e.g., to provide power factor adjustment). The capacitor C1 may be realized by a double layer capacitor, and switches S1, S2, S3, S4 and the switches in the inversion bridge 522 may me realized by field effect transistor (FET) devices. It should be recognized, however, that the depicted components in FIG. 5 are depicted in a general nature, and one of ordinary skill in the art, in view of this disclosure, will appreciate that the components (e.g., switches) may be implemented by a variety of different technologies (e.g., including thyristors, gallium nitride devices, silicon controlled rectifiers (SCRs), and IGBTs). And although it is not depicted, one of ordinary skill in the art will also appreciate that a ground reference may be used as a reference potential and may be used for safety purposes.

The sync signal that is provided to the sync receiver 519 may include several pieces of decodable information. For example, shutdown information may be sent to the sync receiver 519 during an islanded event (e.g., the utility that the series connected inverters are coupled to experiences a failure) or when the series-connectable inverter 502 is simply turned off. In addition, timing and phase information may also be received. The timing information may be indicative of the zero crossings on the AC distribution system, and the phase information may include the desired phase between the current and voltage. The medium for the sync signal may include wireline communication, an RF link, powerline carrier technology, and optical links

Referring next to FIG. 6, it is a block diagram depicting an exemplary control component 621 that may be utilized to realize the control components 321, 421, 521 described with reference to FIGS. 3, 4 and 5. As depicted, a sync pulse 630 is received (e.g., from sync receiver 319, 419, 519) that conveys synchronization information (e.g., originally derived from the supervisory controller 314) and in connection with a phase lock loop (PLL) 632 (which locks on to the frequency (e.g., 60 Hz) of the grid and provides an angle for sine and cosine functions), a normalized reference voltage sine signal 634 is created that represents the AC distribution voltage, and a normalized reference current signal 640 is created that represents AC distribution current.

In the depicted embodiment, phase-control information 636 (e.g., encrypted phase control information) is also received from a sync receiver (e.g., from sync receiver 319, 419, 519), and a PI component 638 provides, with feedback from a reactive power calculation component 660, the phase offset to create a second sine reference 640 representing current, which may or may not be phased with respect to the voltage reference. The two reference signals are multiplied by a multiplier 642 to create a sine-squared function that represents a normalized real-time power delivery signal. A multiplier 644 then multiplies the sine-squared function with a power level coefficient that is output from a maximum power point control 646 component, which may be realized by a variety of known (e.g., “perturb and observe”) techniques and yet to be developed techniques. The resulting power control function is then processed by a up/dn shift register 650 before being passed to a hysteresis controller 652 that operates the power regulation components (e.g., components 420, 520). Switching of the switching components of the inversion bridge 422, 522 is synchronized to the phase current flow (of the AC distribution system) using control signals 641 (which is indicative of phase-current-flow) from the second sine reference 640 and power is inverted in concert with any number of other series-connectable converters connected in series.

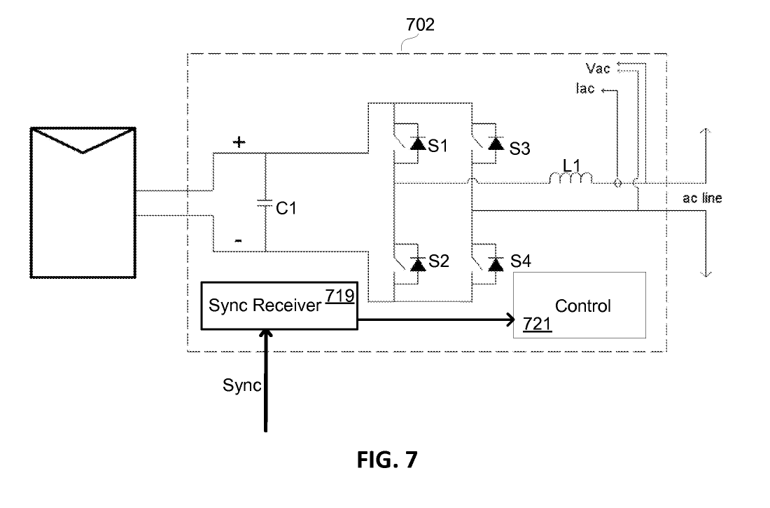

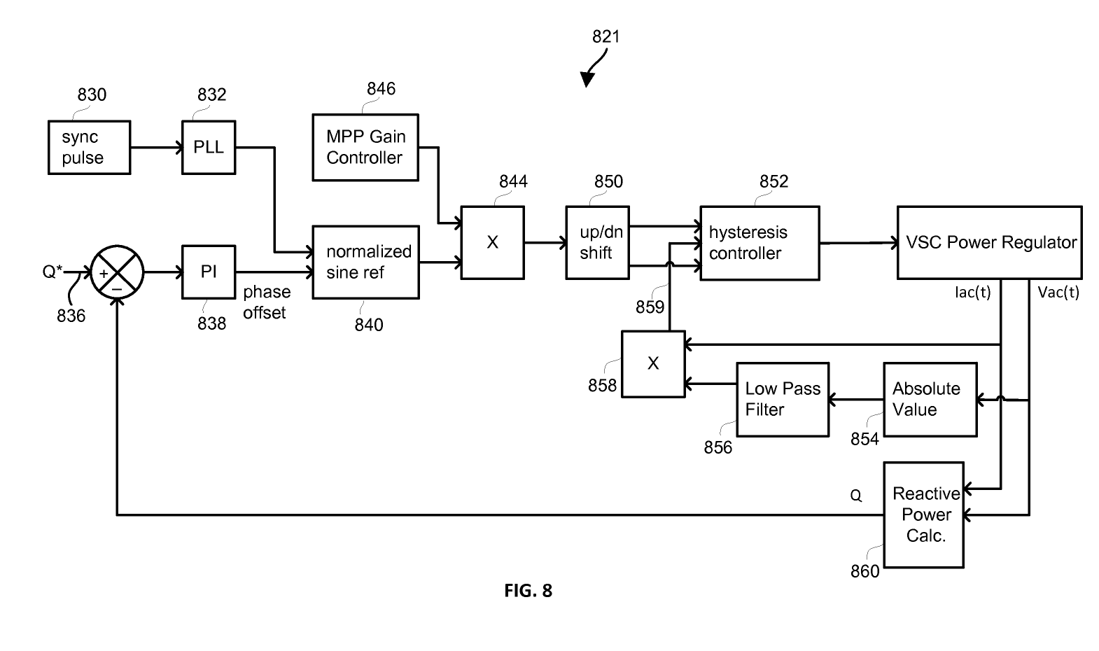

Referring next to FIG. 7, it is a schematic representation of another embodiment of a series-connectable converter 702, which utilizes a voltage source converter. While referring to FIG. 7, reference will also be made to FIGS. 8, 9, and 10 which are block diagrams depicting embodiments of the control portion 721 depicted in FIG. 7. One of ordinary skill in the art will appreciate that the components depicted in FIGS. 8, 9, 10 may be realized by hardware, software, firmware, or a combination thereof. And although not depicted, one of ordinary skill in the art will readily appreciate that the series connectable converter depicted in FIG. 7 may include a maximum power point tracking (MPPT) component at its input, which may be realized by any one of a variety of maximum power point regulators known to those of ordinary skill in the art; thus additional details of the MPPT is not provided herein for clarity.

Referring to FIG. 8, the controller 821 receives a sync pulse 830 and desired line current phase information Q* from a supervisory transmitter (e.g., the supervisory transmitter 314), which are utilized to create a single reference sine signal representing current. More specifically, the sync pulse 830 is received by a phase lock loop (PLL) 832, which utilizes the sync pulse 830 to generate a repeating smooth ramp from zero to 2 pi to generate a normalized sine reference signal 840. And the normalized sine reference signal 840 is imparted with a phase offset from proportional integrator 838 based upon a difference between the desired current phase information Q* and calculated current phase information Q that is calculated by a reactive power calculation component 860 based upon measurements of the current (Iac) and voltage (Vac)(shown in FIG. 7); thus the calculated current phase information Q is indicative of the actual phase of the output current (Iac) relative to the output voltage (Vac) 100341 As shown, the normalized sine reference signal 840 is then multiplied by a multiplier 844 with a power coefficient output from the maximum power point (MPP) logic 846. The resulting power control function that is output by the multiplier 844 is then processed by an up/dn shift register 850 before being passed to a hysteresis controller 852. As shown, the hysteresis controller 852 receives a signal 859, which is representative of delivered power, and the signal 859 generated by multiplying the high-speed feedback-current (Iac) by a local amplitude average of AC terminal voltage (Vac), which is generated by the absolute value component 854 in connection with the low pass filter 856. This signal 859 is then used as the high-speed feedback to the hysteresis current control.

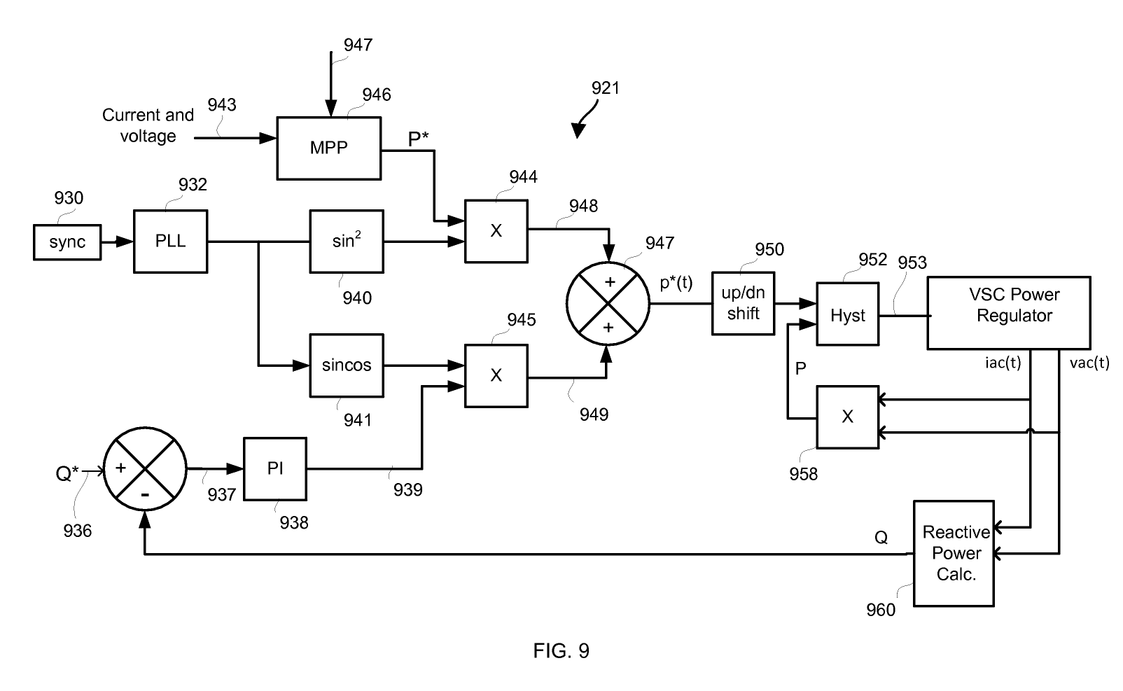

Referring next to FIG. 9 it is a block diagram depicting another exemplary embodiment of a control portion 921 that may be used to implement the control portion 721 depicted in FIG. 7. As shown in this embodiment, a sync pulse 930 is received by the PLL 932 which creates a smooth ramp from zero to 2 pi and then resets (e.g., in a saw tooth manner) that is synchronized with the AC distribution system. And in addition, reactive set point information Q* 936 is received, and any power limit command 947 is also received (e.g., from the supervisory controller 314). In operation, the MPP controller 946 will determine, using current and voltage information 943 from a photovoltaic module, the maximum amount of power that can be extracted from the photovoltaic module and send a power setpoint signal P* signal corresponding to the lesser of the maximum power or a power level that corresponds to a power-limit command 947. Ordinarily the power limit will, by default, be set to a high level. For example, if the panel applying power to the series-connectable DC-to-AC converter 702 is a 280 Watt panel, the limit command 947 may be 300 Watts, but if the utility or owner/operator wants curtailment for some reason, the supervisory controller 314 will send a power-limit command 947 (e.g., indicating all the series-connectable DC-to-AC converters 702 should output 50 Watts) that is received by the MPP component 946, and the MPP component 946 provides a power setpoint signal P* that corresponds to the reduced setpoint (e.g., 50 Watts).

The PLL 932 provides the ability to use a variety of trigonometric functions including sine and cosine waves. As shown, two sine waves are multiplied to create a sine-squared function 940 and a sine and cosine waves are multiplied to create a sine-cosine function 941. The sine-squared function 940 represents real power flow and it is multiplied 944 by the power set point signal P* to obtain a scaled representation of real power flow. And the sine-cosine function 941 represents reactive power, which is multiplied 945 by a phase offset that is obtained from a proportional integrator (PI) 938 that receives a difference 937 between the reactive set point information Q* 936 and calculated reactive power Q 960 (which is indicative of the actual reactive power). As shown, a power p(t) function (a real time function) is obtained by adding 947 the scaled representation of real power flow 948 with the representation of reactive power 949. As a consequence, the p*(t) function includes real and reactive power components and the reactive and real representations may each vary and be reduced to zero to either provide wholly real power, wholly reactive power, or non-zero proportions of each. As shown, the hysteresis control component 952 receives, after processing by the up/dn shift component 950, the p(t) function, and generates a control signal 953 based upon a calculation of actual power obtained from multiplier 958. As shown the control signal 953 controls a voltage source controlled (VSC) power regulator (e.g., the VSC power regulator shown in FIG. 7).

The depicted components in FIG. 9 operate in a power-regulation-control mode of operation. Although power-regulation-control of non-zero, forward power (when the series-connectable converter 702 is applying power) is certainly not a trivial matter, when the power that is applied becomes zero or is reversed, control of the converter 702 requires considerations that are not required in other control schemes. For example, in a current-regulation-control scheme, the current is measured in real time, and zero current is a valid, and easily controlled value, but in a power-regulation-control mode, power can be reduced to zero with any of a zero voltage value, a zero current value, or both a zero voltage and a zero current value, and as a consequence, the power-regulation control loop may become undefined.

And in addition, in a reactive power flow mode (e.g., a reverse power mode), the rules that govern the switching of the H-bridge change and become variable. In a forward power flow mode, for example, switches S1 and S4 depicted in FIG. 7 are triggered longer to provide more power, and are triggered less to provide less power; thus a buck conversion occurs from left to right in FIG. 7.

But when power flows from the AC side to the DC side (from right to left), a boost condition exists, and boost devices have a tendency to put a lot of energy into inductances in the power conversion components, and although the net effect is power moving from the AC side to the DC side, there are periods of time where energy goes into inductances on the AC side (from left to right). Referring to the bridge depicted in FIG. 7 for example, to run power instantaneously in a reverse power flow mode (from the AC side to the DC side), switches S3 and S4 need to be shorted together to build up current in the inductor L1, and then the switches are opened so that the inductor L1 will send its energy via rectification to the capacitor C1. But problematically, when the switches S3, S4 are shorted together, energy will go from left to right. As a consequence, to address this problem, in some embodiments, when operating in a reactive power mode, instead of power regulation, voltage regulation is also utilized.

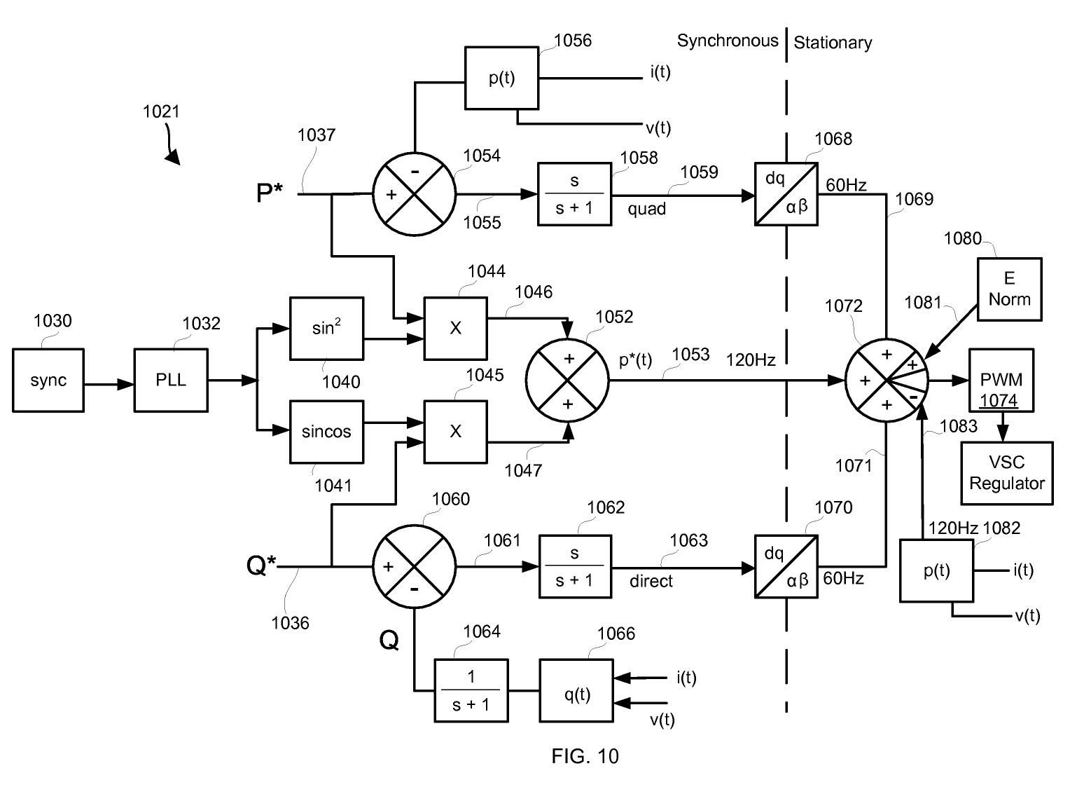

Referring next to FIG. 10 for example, shown is a control portion 1021 that is yet another embodiment of the control portion 721 depicted in FIG. 7. As shown, in this embodiment a sync pulse 1030 is received by the PLL 1032 which creates a smooth ramp from zero to 2 pi (for each sync pulse) and then resets (e.g., in a saw tooth manner) that is synchronized with the AC distribution system. And in addition, reactive set point information Q* 1036 is received, and a power set point signal P* 1037 (e.g., which may be received from a MPP controller such as MPP controller 946). As shown the output of the PLL 1032 is used to create a sine-squared function 1040 (with a normalized amplitude of one) and a sine-cosine function 1041 (with a normalized amplitude of one). The sine-squared function 1040 represents real power flow and it is multiplied 1044 by the power set point signal P* to obtain a scaled representation of real power flow. And the sine-cosine function 1041 represents reactive power, which is multiplied 1045 by a phase offset in the reactive setpoint information 1036. As shown, a power p*(t) function (a real time function) is obtained by adding 1052 the scaled representation of real power flow 1046 with the representation of reactive power 1047. As depicted, the real time power function p*(t), which is a 120 Hz sine wave, is fed to the final stage summer 1072.

As shown, the final stage summer 1072 also receives an output 1069 from a power feedback loop, and an output 1071 from a reactive power feedback loop. As depicted, the power feedback loop includes a power calculation component 1056, which provides a filtered product of the voltage v(t) and current i(t) measured at the output of the converter 702. And the filtered product is compared 1054 with the power setpoint signal P* 1037 to obtain a difference 1055 that is fed to a proportional integrator 1058, which provides a quadrature setpoint 1059 to a synchronous-to-stationary-reference-frame converter 1068 that generates a 60 Hz signal 1069.

The reactive power feedback loop includes a filtered reactive power product q(t) 1066, that is fed to a linear amplifier 1064 before being compared 1060 with the reactive power setpoint Q* 1036. And the difference 1061 between the reactive setpoint Q* and the representation Q of reactive power is fed to a proportional integrator 1062, which provides a direct setpoint signal 1063 to a synchronous-to-stationary-reference-frame converter 1070 that provides a 60 Hz signal 1071.

In addition, an E-normalized feed forward function 1080 provides an output 1081 to the final stage summer 1072 that is representative of the 60 Hz voltage amplitude (or 50 Hz Voltage) that the series-connectable converter 702 contributes to a string (e.g., string 304) of series-connectable converters. For example, if the converter 702 is in a string that consists of N series-connectable converters and the voltage across the string of series connectable converters is, for example, 277 Volts, the output 1081 is representative of 277/N Volts. As depicted, the contribution of the output 1081 of the E-normalized feed forward function 1080 is additive in the final stage summer 1072. The E-normalized feed forward function 1080 may be an additional piece of information that is provided by the supervisory controller 314 along with the synchronization (sync signal), phase (Q*), and power (P*) information. The voltage represented by the output 1081 may be representative of a “base voltage” that each of the series-connectable-converters would need to apply so that collectively the string of series-connectable-converters applies a voltage to a phase leg of a distribution system that neither sends current to, nor draws current from, the phase leg of the distribution system.

And additionally, a power calculation component 1082 provides a filtered power signal 1083, which is a 120 Hz signal indicative of measured power at the output of the series-connectable converter 702, to the final stage summer 1072. And as shown, the final stage summer 1072 provides a control output to a pulse-width-modulation (PWM) component 1074, which controls the bridge of the series-connectable converter 702 to pulse-width modulate its output to provide the power and voltage at the output of the series-connectable converter 702 so that collectively the string of series-connectable converters applies a desired voltage level and phase to a phase leg of a power distribution system.

Functionally, the components 1056, 1054, 1058 of the power feedback loop and components 1066, 1064, 1060, 1062 of the reactive power feedback loop operate as a synchronous-reference-frame controller, and the components 1030, 1032, 1040, 1041, 1044, 1045, 1052 function as a real-time-power-function-controller. Collectively, the controller 1021 in this embodiment operates as a gain compensated E-normalized feed forward control system.

In the exemplary embodiment, when the converter 702 is operating in a reactive power mode, the controller 1021 may cease to operate in a power-mode of regulation and change to a voltage-mode of regulation. More specifically, when operating in a reactive power mode, the feedback of the 120 Hz power inputs 1053, 1083 to the final stage summer 1072 are suspended and the controller utilizes the 60 Hz inputs 1069, 1071, 1081 to control the pulse-width modulation 1074 using voltage-mode of regulation. And in many implementations, when the output voltage v(t) of the series-connectable converter 702 approaches zero, the feedback of the 120 Hz power inputs 1053, 1083 to the final stage summer 1072 is suspended and the controller utilizes the 60 Hz inputs 1069, 1071, 1081 to control the pulse-width modulation 1074.

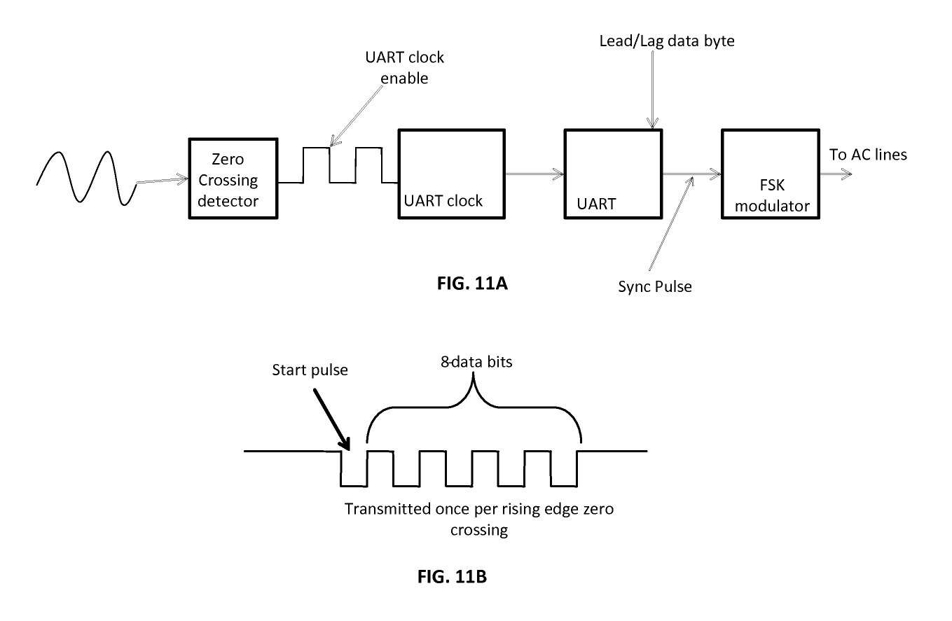

Referring next to FIGS. 11A and 11B, shown are a block diagram depicting components of a transmitter and sync pulses that are transmitted by the transmitter, respectively. The transmitter depicted in FIG. 11A may be implemented in the supervisory controller 314, and as depicted in operation zero crossings at the AC distribution system are detected by a zero crossing detector, and encoded (e.g., by the FSK modulator) on to the AC lines that are coupled to the series connectable converters 302. Although a power-line carrier approach is used in this embodiment to transmit synchronization information to the series-connectable converters 302, this is certainly not required and a variety of other communication approaches (e.g., wire-line and wireless) and encoding techniques may be used to transmit synchronization information. Although a frequency shift keying (FSK) modulator is shown in FIG. 11A, one of ordinary skill in the art will recognize that alternative modulation techniques such as amplitude modulation and phase shift keying techniques, among others, may be utilized.

In alternative implementations, zero crossing synchronization may be transmitted to the series connectable converters by turning on a carrier wave when the AC line is above zero and turning it off when it is below zero. This signal may be transmitted on a separate channel from the regular PLC command and control signals that provide maximum power, reactive power (also referred to as phase or VAR setpoint), and on/off signals to the series connectable converters. Data reporting relative to the health and power output of each series connectable converter may also be communicated back to the supervisory controller via this PLC channel

Referring next to FIGS. 12A and 12B, shown are a block diagram depicting components of an exemplary sync receiver (that may be used to realize the sync receivers 319, 419, 519, 619, 719 described herein) and decoded sync pulses that may be utilized by the controllers described herein with reference to FIGS. 6, 8, 9, and 10. As shown the synchronization information is decoded to create a sync pulse (e.g., sync pulse 630, 830, 930, 1030) for a phase lock loop (e.g., PLL 732, 832, 932, 1032) and line current phase-control information Q* (e.g., phase-control information 636, 836, 936, 1036) is fed to a control component (e.g., control components 321, 421,521,621,721,821,921,1020.

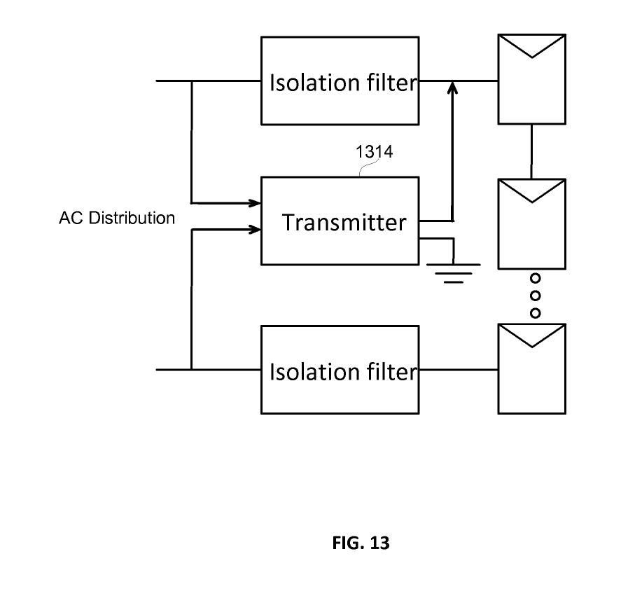

Referring next to FIG. 13, shown is a block diagram depicting an exemplary arrangement for coupling a supervisory transmitter 1314 to an AC distribution system (e.g., to detect zero crossings) and provide synchronization information (via power-line carrier) to series-connected inverters 302 while preventing (using isolation filters) the synchronization information from propagating to AC distribution system. As one of ordinary skill in the art will appreciate, the isolation filters may be designed using, for example, a series trap to ground on the AC side and a parallel trap (on photovoltaic side) that isolates the frequencies and prevents a short to ground.

It is highly desirable with a device appropriate for connection to a single photovoltaic module to be as small as practical. This allows for effective mounting of the device, quite possibly as part of the photovoltaic module itself. The previously described characteristic of prior parallel connected devices where a low DC voltage must be inverted to a relatively high AC voltage makes physical compactness difficult due to the multiple DC-to-AC power processing stages and ratio-changing transformers required. Several embodiments of the series-connectable converters 302 described herein do not contain multiple DC-to-AC stages nor do they require a transformer. This leads to a unique characteristic of the series connectable device: module referencing.

Of great interest to photovoltaic installers and regulators is voltage applied, with respect to ground, to the modules and any other equipment. Although these voltages are minimal in the case of the previously described prior art parallel connected module-level inverters due to the presence of an isolating transformer in the inverter, for the conventional stringing approach depicted in FIG. 1 applied voltages are of considerable concern. While there are several accepted methods of ground-referencing a conventionally constructed array, the applied voltage to ground at any point in the system is a function of the ground reference electrical location, the position of observed point in the stringing system, and the operational condition of the array. For instance, the applied voltage to ground on the hot leg, or collecting conductor furthest away from the ground reference, is vastly different between a low voltage condition seen while heavily loaded on a hot day and an open-circuit condition during a cold day. It is this operational dependence of voltage to ground that constrains much of photovoltaic system design and regulation.

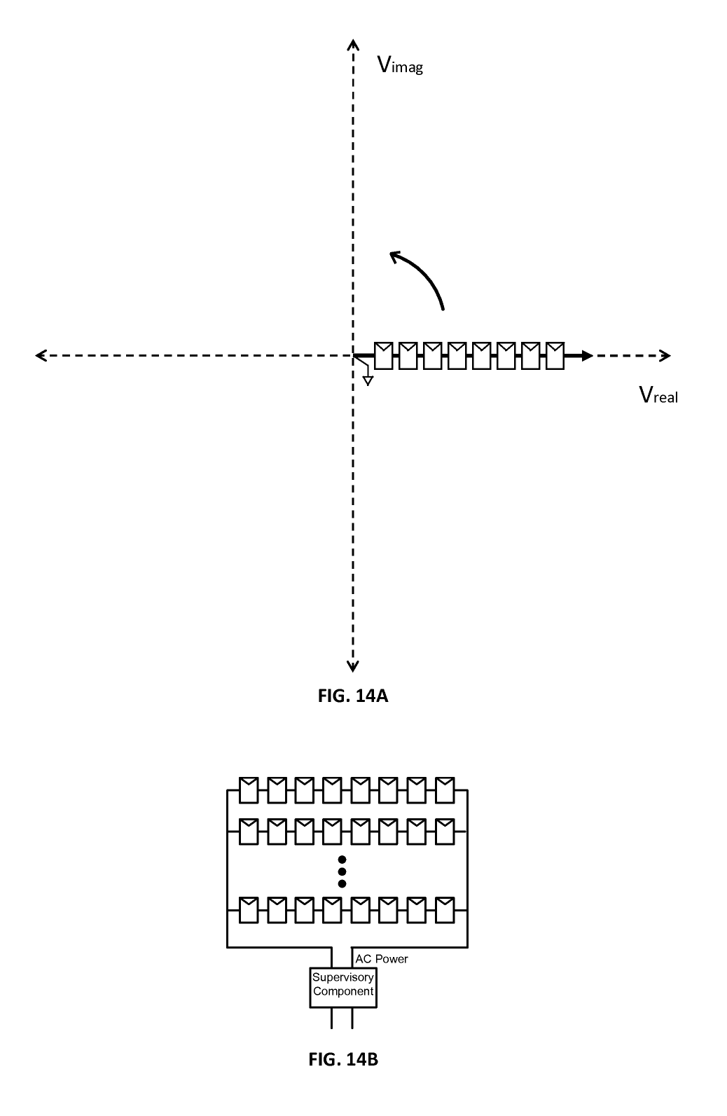

For many embodiments of the series-connectable (e.g., transformerless) inverters described herein, the voltage of the DC-to-AC conversion modules with respect to ground is an AC voltage, not a DC voltage (as it is for conventional inverters both large and module-level). Although the magnitude of the voltage with respect to ground is a function of the series-connectable DC-to-AC inverter position in the string, in several embodiments it is not at all dependent on the operational conditions of the module or array. FIG. 14A shows a phasor diagram of eight series connected converters operating as a string into a single phase grid connection. The panel closest to the neutral, or ground referenced collecting conductor, sees a small magnitude alternating voltage to ground. The panel furthest from the neutral sees an alternating voltage to ground very near the phase voltage to ground. These applied voltages are consistent as long as the grid is connected and do not change as a function of array operation. While the series connected device sees only a small differential voltage, which is a substantially smaller than the phase voltage, its voltage to ground tolerance must be appropriate for the applied phase to ground voltage. Provided this, the sum of the cumulative differential device outputs may be stacked arbitrarily high.

As shown in FIGS. 14-17, the devices and their respective supervisory controller/transmitter, may be connected in a wide variety of grid configurations. These include single phase, split-single phase, three phase wye and delta and all ground referencing variants of each. Although FIG. 14A depicts a single string of eight series-connected converters and corresponding modules, as shown in FIG. 14B, the single string depicted in FIG. 14A may be realized by several parallel strings, and each of the parallel strings may include series-connectable converters.

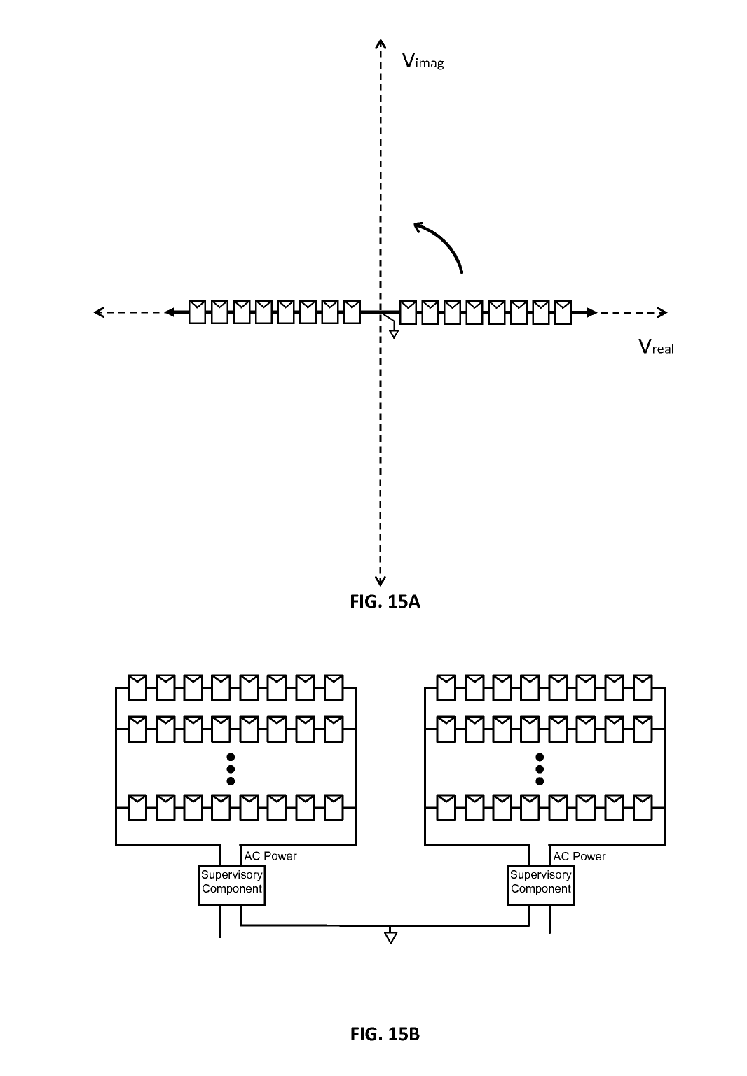

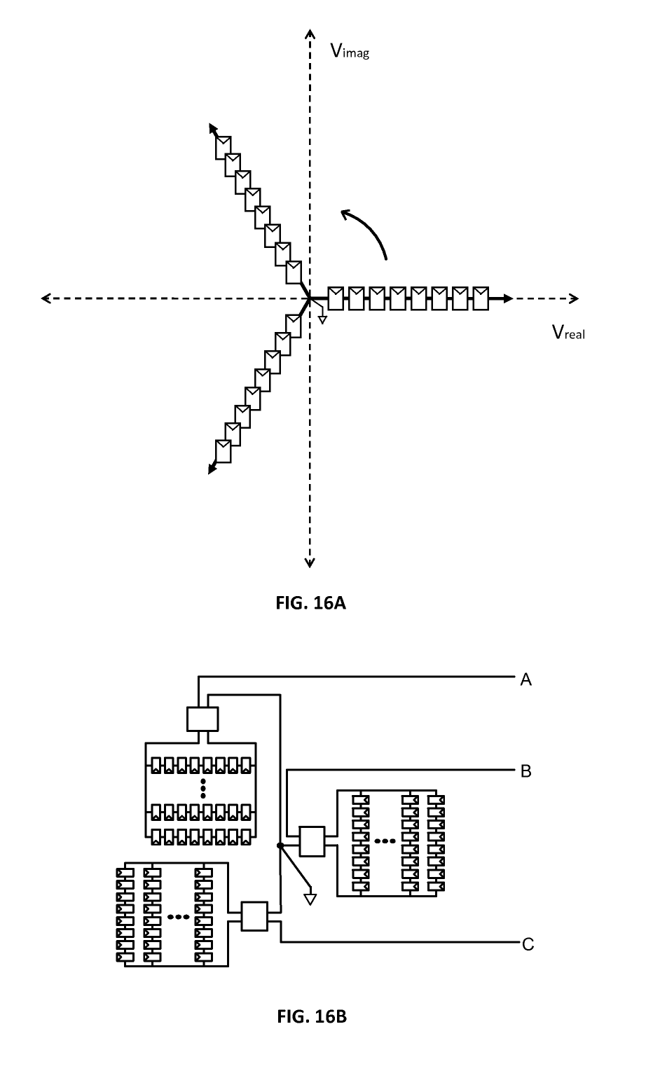

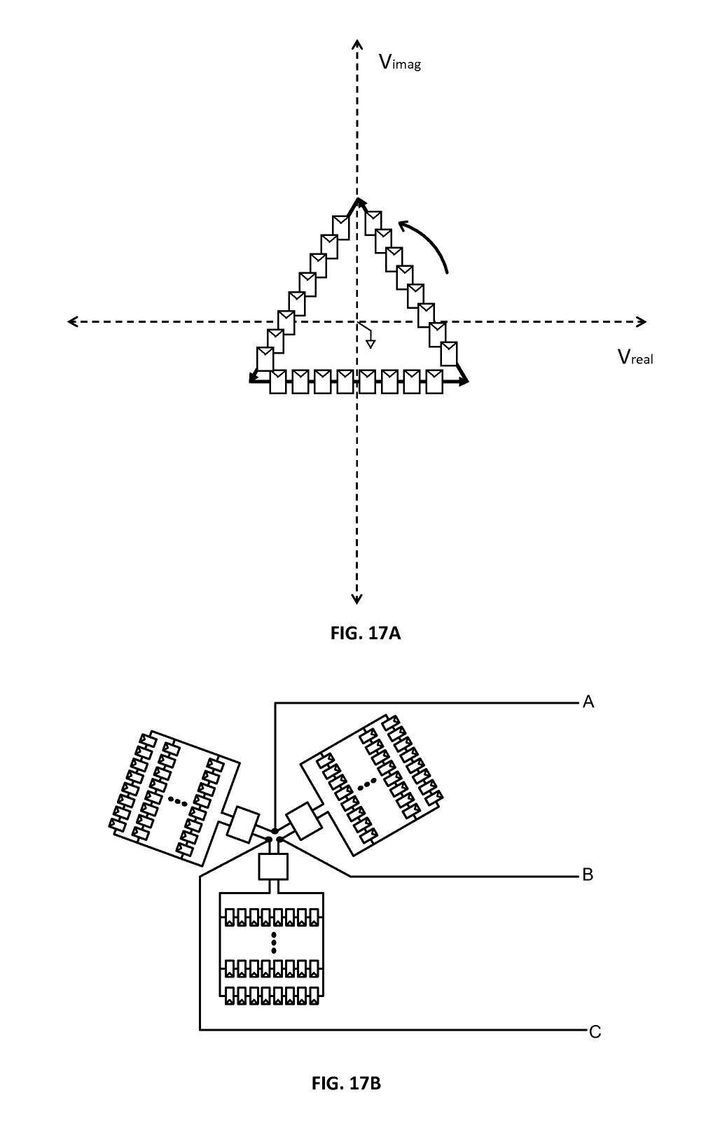

Referring to FIGS. 15A and 15B shown are, respectively, a phasor diagram of series connected converters operating as strings into a split-single phase grid connection and exemplary implementation of a split-single configuration. FIG. 16A depicts a phasor diagram of series connected converters operating as strings into a three-phase wye grid connection, and FIG. 16B depicts an exemplary implementation of the three phase wye configuration. And FIG. 17A depicts a phasor diagram of series connected converters operating as strings into a three-phase delta grid connection, and FIG. 17B depicts an exemplary implementation of the three-phase delta configuration.

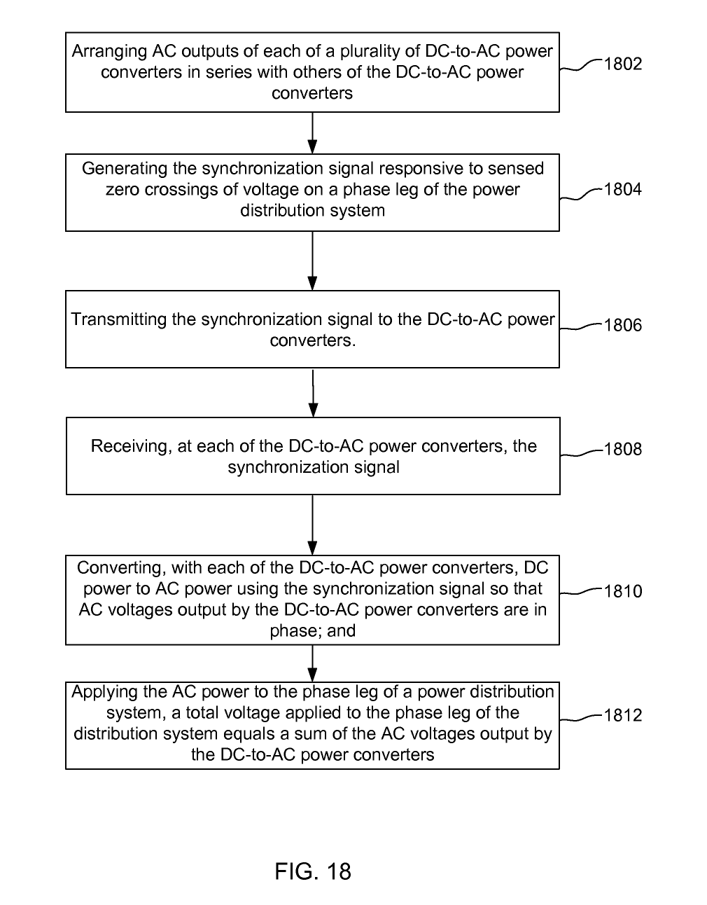

Referring next to FIG. 18, it is a flowchart depicting a method that may be traversed in connection with the embodiments disclosed herein. As shown, in this method the AC outputs of each of a plurality of DC-to-AC power converters (e.g., the DC-to-AC power converters 302) are arranged in series with others of the DC-to-AC power converters (Block 1802). In addition a synchronization signal is generated (e.g., by the supervisory controller 314) responsive to zero crossings of voltage that are sensed on the phase of a power distribution system (Block 1804), and the synchronization signal is transmitted to the DC-to-AC power converters (Block 1806). As shown, the synchronization signal is received at each of the DC-to-AC power converters (Block 1808), and with each of the DC-to-AC power converters, DC power is converted to AC power using the synchronization signal so that AC voltages output by the DC-to-AC power converters are in phase (Block 1810). The AC power is then applied to the phase of the power distribution system, and the total voltage applied to the phase of the distribution system equals a sum of the AC voltages output by the DC-to-AC power converters (Block 1812).

In one or more exemplary embodiments, the functions described may be implemented in hardware, software, firmware, or any combination thereof. If implemented in software, the functions may be stored on or transmitted over as one or more instructions or code on a non-transitory computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise flash memory (e.g. NAND memory) RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In conclusion, the present invention provides, among other things, a system and method for AC grid connection of series connected photovoltaic converters. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A system for converting DC power to AC power, the system comprising a master controller that couples to a phase leg of a power distribution system and provides a synchronization signal and a power control signal, the phase leg of the power distribution system having a phase voltage;
a plurality of DC-to-AC series-connectable power converters arranged in series in a string, each of the DC-to-AC series-connectable power converters receives and uses the synchronization signal and the power signal to convert a variable DC voltage from a corresponding one of a plurality of photovoltaic modules to an AC voltage so that a plurality of corresponding AC voltages are generated by the plurality of series-connectable power converters, and collectively the plurality of corresponding AC voltages add up the phase voltage, and each of the series-connectable power converters controls, responsive to the synchronization signal, the AC voltage so that the plurality of corresponding variable AC voltages are all in phase.

2. The system of claim 1, wherein each of the series-connectable power converters includes:
a DC-input side including terminals to couple to a DC voltage applied by a corresponding one of the plurality of photovoltaic modules;
an AC-output side including terminals to apply an AC voltage that is based upon a level of the DC voltage;
a receiver to receive the synchronization signal and the power signal;
a power conversion component to convert the DC potential applied by the corresponding one of the plurality of photovoltaic modules to the AC voltage and control voltage; and
a controller that controls the power conversion component responsive to the received synchronization signal and the power signal

3. The system of claim 1, wherein a length of the string is determined by a ratio of a nominal, individual voltage of the AC voltage and an overall phase voltage.

4. The system of claim 1 wherein multiple strings of the series-connectable power converters are combined.

5. The system of claim 4, wherein the combined strings are connected to the phase leg.

6. The system of claim 5, wherein the combined strings are connected across a single-phase to neutral applied voltage.

7. The system of claim 5, wherein the combined strings are connected across a split-single-phase applied voltage.

8. The system of claim 4, wherein multiple sets of combined strings are connected to respective phases in a polyphase system.

9. The system of 8, wherein the combined strings are connected across the line-to-neutral phase voltages of the polyphase system.

10. The system of claim 8, wherein the combined strings are connected across the line-to-line phase voltages of the polyphase system.

11. A DC-to-AC series-connectable power converter comprising:
a DC-input side including terminals to couple to a DC potential applied by a corresponding one of a plurality of photovoltaic modules;
an AC-output side including terminals to apply an AC voltage;
a receiver to receive a synchronization signal and a power signal;
a power conversion component to convert the DC potential applied by the corresponding one of a plurality of photovoltaic modules to the AC voltage; and
a controller that controls the power conversion component, responsive to the received synchronization signal and the power signal, so that a phase of the AC voltage is synchronized with the synchronization signal and a power level output from the DC-to-AC series-connectable power converter is consistent with the power signal.

12. The DC-to-AC series-connectable power converter of claim 11, wherein the power conversion component is configured to provide reactive power flow responsive to the controller when the controller receives a reactive power flow signal that is received at the receiver.

13. The DC-to-AC series-connectable power converter of claim 11, wherein the synchronization information is provided by a common-mode signal that is transmitted by a supervisory controller and received by the receiver.

14. The DC-to-AC series-connectable power converter of claim 13, including a line output ac-bypass capacitor enabling transmission of the synchronization signal through the DC-to-AC series-connectable power converter.

15. The DC-to-AC series-connectable power converter of claim 13, wherein the receiver receives the synchronization information via the common-mode signal with respect to a provided signal ground.

16. The DC-to-AC series-connectable power converter of claim 11, wherein the receiver receives phase information and the controller controls the power conversion component based upon the phase information to provide active and reactive power control.

17. The DC-to-AC series-connectable power converter of claim 11, wherein the power conversion component is a current source conversion component that may be placed in series with other DC-to-AC series-connectable power converters using a real-time power regulation loop using hysteretic modulation of a sine-squared power function that is the product of synchronized synthetic voltage reference sine, a phased current reference sine and a power scaling coefficient based upon real time maximum power point tracking conditions.

18. The DC-to-AC series-connectable power converter of claim 11, wherein the power conversion component is a voltage source converter.

19. The DC-to-AC series-connectable power converter of claim 18, wherein the voltage source converter includes a control portion that operates in a stationary frame of reference.

20. The DC-to-AC series-connectable power converter of claim 18, wherein the voltage source converter includes a control portion that operates in a synchronous reference frame.

21. The DC-to-AC series-connectable power converter of claim 20, wherein the control portion utilizes pulse-width modulation to control the voltage source converter.

22. A method for converting DC power to AC power comprising:
arranging AC outputs of each of a plurality of DC-to-AC power converters in series with others of the DC-to-AC power converters;
receiving, at each of the DC-to-AC power converters, a synchronization signal;
converting, with each of the DC-to-AC power converters, DC power to AC power using the synchronization signal so that AC voltages output by the DC-to-AC power converters are in phase; and
applying the AC power to a phase leg of a power distribution system, a total voltage applied to the phase leg of the distribution system equals a sum of the AC voltages output by the DC-to-AC power converters.

23. The method of claim 22 including:
generating the synchronization signal responsive to sensed zero crossings of voltage on the phase of the power distribution system; and
transmitting the synchronization signal to the DC-to-AC power converters.

24. The method of claim 22, wherein the applied voltage to ground seen by each of the DC-to-AC power converters is solely a function of its position in the series connected string and applied phase voltage.

25. The method of claim 22 including arranging the AC outputs of each of a plurality of DC-to-AC power converters in series with others of the DC-to-AC power converters without the use of galvanically isolating transformers.
